(19) United States
(12) Patent Application Publication
(10) Pub. No.: US 2005/0223201 A1
(43) Pub. Date: Oct. 6, 2005

(54) Facilitating rapid progress while speculatively executing code in scout mode

(76) Inventors: Marc Tremblay, Menlo Park, CA (US); Shailender Chaudhry, San Francisco, CA (US); Quinn A. Jacobson, Sunnyvale, CA (US)

Correspondence Address: A. RICHARD PARK, REG. NO. 41241;PARK, VAUGHAN & FLEMING LLP, 2820 FIFTH STREET, DAVIS, CA, 95616, US

(21) Appl. No.: 11/095,644

(22) Filed: Mar. 30, 2005

Related U.S. Application Data
(60) Provisional application No. 60/558,017, filed on Mar. 30, 2004.

(51) Int. Cl. G06F 9/00

(52) U.S. Cl. 712/235

(57) ABSTRACT

One embodiment of the present invention provides a processor that facilitates rapid progress while speculatively executing instructions in scout mode. During normal operation, the processor executes instructions in a normal execution mode. Upon encountering a stall condition, the processor executes the instructions in a scout mode, wherein the instructions are speculatively executed to prefetch future loads, but wherein results are not committed to the architectural state of the processor. While speculatively executing the instructions in scout mode, the processor maintains dependency information for each register indicating whether or not a value in the register depends on an unresolved data-dependency. If an instruction to be executed in scout mode depends on an unresolved data dependency, the processor executes the instruction as a NOOP so that the instruction executes rapidly without tying up computational resources. The processor also propagates dependency information indicating an unresolved data dependency to a destination register for the instruction.

### RELATED APPLICATION

This application hereby claims priority under 35 U.S.C. §119 to U.S. Provisional Patent Application No. 60/558,017, filed on 30 Mar. 2004, entitled “Facilitating rapid progress while speculatively executing code in scout mode,” by inventors Marc Tremblay, Shailender Chaudhry, and Quinn A. Jacobson (Attorney Docket No. SUN04-0059PSP). The subject matter of this application is also related to the subject matter of a co-pending non-provisional United States patent application entitled, “Generating Prefetches by Speculatively Executing Code Through Hardware Scout Threading” by inventors Shailender Chaudhry and Marc Tremblay, having Ser. No. 10/741,944, and filing date 19 Dec. 2003 (Attorney Docket No. SUN-P8383-MEG).

### BACKGROUND

1. Field of the Invention

The present invention relates to the design of processors within computer systems. More specifically, the present invention relates to a method and an apparatus that facilitates rapid progress while speculatively executing code in scout mode after encountering a stall condition.

2. Related Art

Advances in semiconductor fabrication technology have given rise to dramatic increases in microprocessor clock speeds. This increase in microprocessor clock speeds has not been matched by a corresponding increase in memory access speeds. Hence, the disparity between microprocessor clock speeds and memory access speeds continues to grow, and is beginning to create significant performance problems. Execution profiles for fast microprocessor systems show that a large fraction of execution time is spent not within the microprocessor core, but within memory structures outside of the microprocessor core. This means that the microprocessor systems spend a large fraction of time waiting for memory references to complete instead of performing computational operations.

Efficient caching schemes can help reduce the number of memory accesses that are performed. However, when a memory reference, such as a load operation generates a cache miss, the subsequent access to level-two (L2) cache or memory can require dozens or hundreds of clock cycles to complete, during which time the processor is typically idle, performing no useful work.

A number of techniques are presently used (or have been proposed) to hide this cache-miss latency. Some processors support out-of-order execution, in which instructions are kept in an issue queue, and are issued “out-of-order” when operands become available. Unfortunately, existing out-of-order designs have a hardware complexity that grows quadratically with the size of the issue queue. Practically speaking, this constraint limits the number of entries in the issue queue to one or two hundred, which is not sufficient to hide memory latencies as processors continue to get faster. Moreover, constraints on the number of physical registers, are available for register renaming purposes during out-of-order execution also limits the effective size of the issue queue.

Some processor designers have proposed entering a scout-ahead execution mode during processor stall conditions. In this scout-ahead mode, instructions are speculatively executed to prefetch future loads, but results are not committed to the architectural state of the processor. For example, see U.S. patent application Ser. No. 10/741,944, filed Dec. 19, 2003, entitled, “Generating Prefetches by Speculatively Executing Code through Hardware Scout Threading,” by inventors Shailender Chaudhry and Marc Tremblay. This solution to the latency problem eliminates the complexity of the issue queue and the rename unit, and also achieves memory-level parallelism.

However, this scout-ahead design performs a large number of unnecessary computational operations while in scout-ahead mode. In particular, while operating in scout-ahead mode, this scout-ahead design executes “unresolved instructions,” which depend upon unresolved data dependencies, even though these unresolved instructions cannot produce valid results. This leads to a number of performance problems. (1) Executing unresolved instructions ties up computational resources, which could otherwise be used to execute other instructions with resolved operands. (2) An unresolved instruction is often forced to wait until a processor scoreboard indicates that all source operands are available for the unresolved instruction, even though the unresolved instruction will not produce a valid result, and this waiting can unnecessarily delay execution of subsequent instructions. (3) Instructions that use results from an unresolved instruction are often forced to wait until the unresolved instruction completes, even though the unresolved instruction does not produce a valid result.

Hence, what is needed is a method and an apparatus for executing instructions in scout-ahead mode without the above-described performance problems.

### SUMMARY

One embodiment of the present invention provides a processor that facilitates rapid progress while speculatively executing instructions in scout mode. During normal operation, the processor executes instructions in a normal execution mode. Upon encountering a stall condition, the processor executes the instructions in a scout mode, wherein the instructions are speculatively executed to prefetch future loads, but wherein results are not committed to the architectural state of the processor. While speculatively executing the instructions in scout mode, the processor maintains dependency information for each register indicating whether or not a value in the register depends on an unresolved data-dependency. If an instruction to be executed in scout mode depends on an unresolved data dependency, the processor executes the instruction as a NOOP so that the instruction executes rapidly without tying up computational resources. The processor also propagates dependency information indicating an unresolved data dependency to a destination register for the instruction.

In a variation on this embodiment, prior to executing the instructions in scout mode, the processor checkpoints its architectural state.

In a variation on this embodiment, when the stall condition is resolved, the processor resumes non-speculative execution of the instructions in normal mode from the point of the stall condition.

In a variation on this embodiment, while speculatively executing the instructions in scout mode, the processor skips execution of floating-point and other long latency operations.

In a variation on this embodiment, the processor maintains dependency information for each register in scout mode by: maintaining a “not there bit” for each register, indicating whether a value in the register can be resolved; setting the not there bit of a destination register if a load has not returned a value to the destination register; and setting the not there bit of a destination register of an instruction if the not there bit of any source register of the instruction is set.

In a variation on this embodiment, executing the instruction as a NOOP involves: not using computational resources to perform the instruction; and not blocking other instructions from using the computational resources.

In a variation on this embodiment, the computational resources include: a memory pipe; one or more arithmetic logic units (ALUs); and a branch pipe.

In a variation on this embodiment, executing the instruction as a NOOP involves allowing the instruction to issue even if the processor's scoreboard indicates that a source operand for the instruction is not available.

In a variation on this embodiment, the processor can issue multiple instructions that belong to the same issue group simultaneously. In this variation, executing the instruction as a NOOP involves allowing other instructions in the same issue group to issue despite a data dependency on the instruction.

In a variation on this embodiment, determining if an instruction to be executed in scout mode depends on an unresolved data dependency involves considering both direct dependencies on source registers for the instruction, and intra-group dependencies on source registers for other instructions in the same issue group.

In a variation on this embodiment, an unresolved data dependency can include: a use of an operand that has not returned from a preceding load miss; a use of an operand that has not returned from a preceding translation lookaside buffer (TLB) miss; a use of an operand that has not returned from a preceding full or partial read-after-write (RAW) from store buffer operation; and a use of an operand that depends on another operand that is subject to an unresolved data dependency.

In a variation on this embodiment, the stall condition can include: a memory barrier operation; a load buffer full condition; and a store buffer full condition.

### BRIEF DESCRIPTION OF THE FIGURES

FIG. 1 illustrates a processor within a computer system in accordance with an embodiment of the present invention.

FIG. 2 presents a flow chart illustrating the speculative execution process in accordance with an embodiment of the present invention.

FIG. 3 illustrates dependencies and resource hazards between instructions within an issue group in accordance with an embodiment of the present invention.

FIG. 4 presents a flow chart illustrating the process of speculatively executing an instruction in scout mode in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

Processor

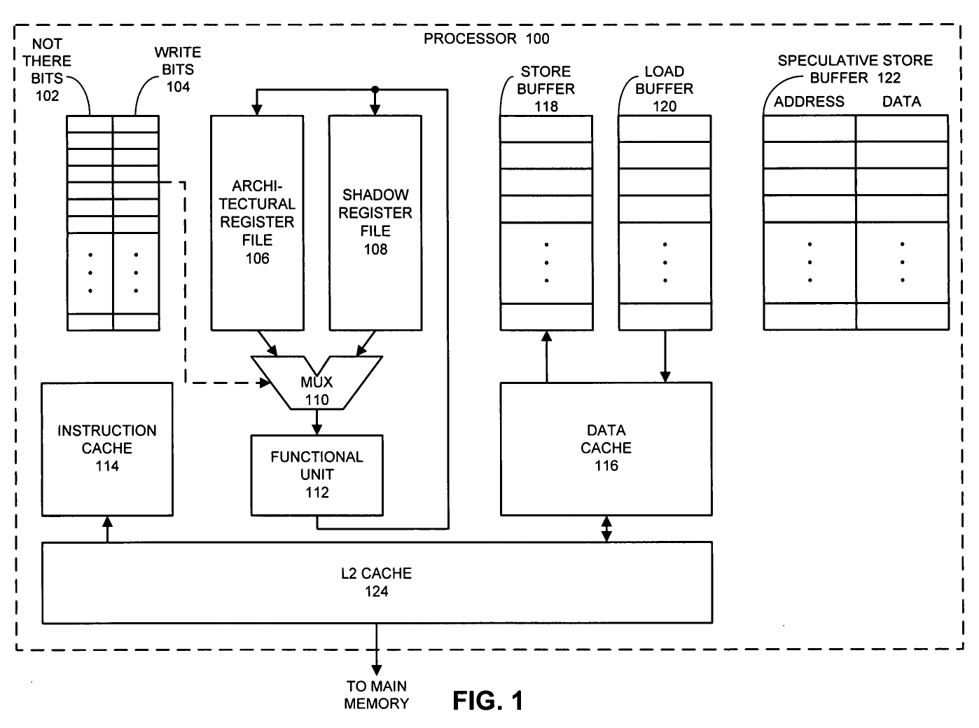

FIG. 1 illustrates a processor 100 within a computer system in accordance with an embodiment of the present invention. The computer system can generally include any type of computer system, including, but not limited to, a computer system based on a microprocessor, a mainframe computer, a digital signal processor, a portable computing device, a personal organizer, a device controller, and a computational engine within an appliance.

Processor 100 contains a number of hardware structures found in a typical microprocessor. More specifically, processor 100 includes and architectural register file 106, which contains operands to be manipulated by processor 100. Operands from architectural register file 106 pass through a functional unit 112, which performs computational operations on the operands. Results of these computational operations return to destination registers in architectural register file 106.

Processor 100 also includes instruction cache 114, which contains instructions to be executed by processor 100, and data cache 116, which contains data to be operated on by processor 100. Data cache 116 and instruction cache 114 are coupled to Level-Two cache (L2) cache 124, which is coupled to memory controller 111. Memory controller 111 is coupled to main memory, which is located off chip. Processor 100 additionally includes load buffer 120 for buffering load requests to data cache 116, and store buffer 118 for buffering store requests to data cache 116.

Processor 100 also contains a number of hardware structures that do not exist in a typical microprocessor, including shadow register file 108, “not there bits” 102, “write bits” 104, multiplexer (MUX) 110 and speculative store buffer 122.

Shadow register file 108 contains operands that are updated during speculative execution in accordance with an embodiment of the present invention. This prevents speculative execution from affecting architectural register file 106. (Note that a processor that supports out-of-order execution can also save its name table—in addition to saving its architectural registers—prior to speculative execution.)

Note that each register in architecture register file 106 is associated with a corresponding register in shadow register file 108. Each pair of corresponding registers is associated with a “not there bit” (from not there bits 102). If a not there bit is set, this indicates that the contents of the corresponding register cannot be resolved. For example, the register may be awaiting a data value from a load miss that has not yet returned, or the register may be waiting for a result of an operation that has not yet returned (or an operation that is not performed) during speculative execution.

Each pair of corresponding registers is also associated with a “write bit” (from write bits 104). If a write bit is set, this indicates that the register has been updated during speculative execution, and that subsequent speculative instructions should retrieve the updated value for the register from shadow register file 108.

Operands pulled from architectural register file 106 and shadow register file 108 pass through MUX 110. MUX 110 selects an operand from shadow register file 108 if the write bit for the register is set, which indicates that the operand was modified during speculative execution. Otherwise, MUX 110 retrieves the unmodified operand from architectural register file 106.

Speculative store buffer 122 keeps track of addresses and data for store operations to memory that take place during speculative execution. Speculative store buffer 122 mimics the behavior of store buffer 118, except that data within speculative store buffer 122 is not actually written to memory, but is merely saved in speculative store buffer 122 to allow subsequent speculative load operations directed to the same memory locations to access data from the speculative store buffer 122, instead of generating a prefetch.

Speculative Execution Process

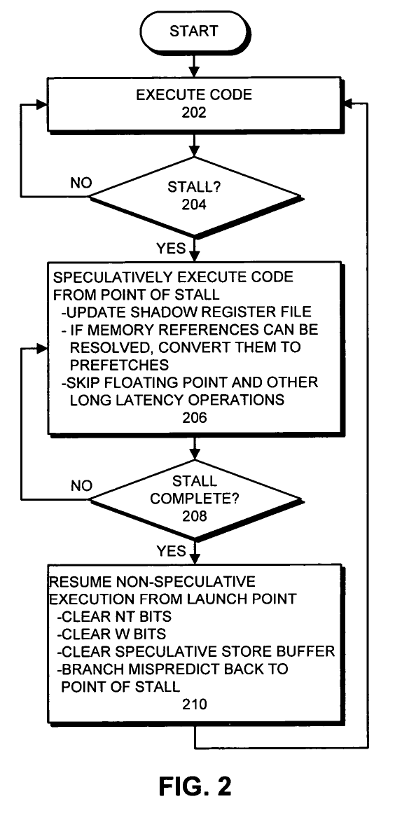

FIG. 2 presents a flow chart illustrating the speculative execution process in accordance with an embodiment of the present invention. The system starts by executing code non-speculatively (step 202). Upon encountering a stall condition during this non-speculative execution, the system speculatively executes code from the point of the stall (step 206). (Note that the point of the stall is also referred to as the “launch point.”)

In general, the stall condition can include and type of stall that causes a processor to stop executing instructions. For example, the stall condition can include a “load miss stall” in which the processor waits for a data value to be returned during a load operation. The stall condition can also include a “store buffer full stall,” which occurs during a store operation, if the store buffer is full and cannot accept a new store operation. The stall condition can also include a “memory barrier stall,” which takes place when a memory barrier is encountered and processor has to wait for the load buffer and/or the store buffer to empty. In addition to these examples, any other stall condition can trigger speculative execution. Note that an out-of-order machine will have a different set of stall conditions, such as an “instruction window full stall.” (Furthermore, note that although the present invention is not described with respect to a processor with an out-of-order architecture, the present invention can be applied to a processor with an out-of-order architecture.)

During the speculative execution in step 206, the system updates the shadow register file 108, instead of updating architectural register file 106. Whenever a register in shadow register file 108 is updated, a corresponding write bit for the register is set.

If a memory reference is encountered during speculative execution, the system examines the not there bit for the register containing the target address of the memory reference. If the not there bit of this register is unset, which indicates the address for the memory reference can be resolved, the system issues a prefetch to retrieve a cache line for the target address. In this way, the cache line for the target address will be loaded into cache when normal non-speculative execution ultimately resumes and is ready to perform the memory reference. Note that this embodiment of the present invention essentially converts speculative stores into prefetches, and converts speculative loads into loads to shadow register file 108.

The not there bit of a register is set whenever the contents of the register cannot be resolved. For example, as was described above, the register may be waiting for a data value to return from a load miss, or the register may be waiting for the result of an operation that has not yet returned (or an operation that is not performed) during speculative execution. Also note that the not there bit for a destination register of a speculatively executed instruction is set if any of the source registers for the instruction have their not bits that are set, because the result of the instruction cannot be resolved if one of the source registers for the instruction contains a value that cannot be resolved. Note that during speculative execution a not there bit that is set can be subsequently cleared if the corresponding register is updated with a resolved value.

In one embodiment of the present invention, the systems skips floating point and other long latency operations during speculative execution, because the floating-point operations are unlikely to affect address computations. Note that the not there bit for the destination register of an instruction that is skipped must be set to indicate that the value in the destination register has not been resolved.

When the stall conditions completes, the system resumes normal non-speculative execution from the launch point (step 210). This can involve performing a “flash clear” operation in hardware to clear not there bits 102, write bits 104 and speculative store buffer 122. It can also involve performing a “branch-mispredict operation” to resume normal non-speculative execution from the launch point. Note that that a branch-mispredict operation is generally available in processors that include a branch predictor. If a branch is mispredicted by the branch predictor, such processors use the branch-mispredict operation to return to the correct branch target in the code.

In one embodiment of the present invention, if a branch instruction is encountered during speculative execution, the system determines if the branch is resolvable, which means the source registers for the branch conditions are “there.” If so, the system performs the branch. Otherwise, the system defers to a branch predictor to predict where the branch will go.

Note that prefetch operations performed during the speculative execution are likely to improve subsequent system performance during non-speculative execution.

Also note that the above-described process is able to operate on a standard executable code file, and hence, is able to work entirely through hardware, without any compiler involvement.

Executing Instructions with Unresolved Data Dependencies as NOOPs

Recall that some scout-ahead designs perform a large number of unnecessary computational operations while in scout-ahead mode. In particular, some designs execute “unresolved” instructions, which depend upon unresolved data dependencies, even though these unresolved instructions cannot produce valid results.

In one embodiment of the present invention, these unnecessary computational operations are avoided by executing unresolved instructions as “NOOPs,” which do not tie up computational resources, and which do not cause subsequent dependent instructions to wait. In describing this embodiment, we start by discussing dependencies and resource hazards that must be considered during instruction execution.

Dependencies and Resource Hazards

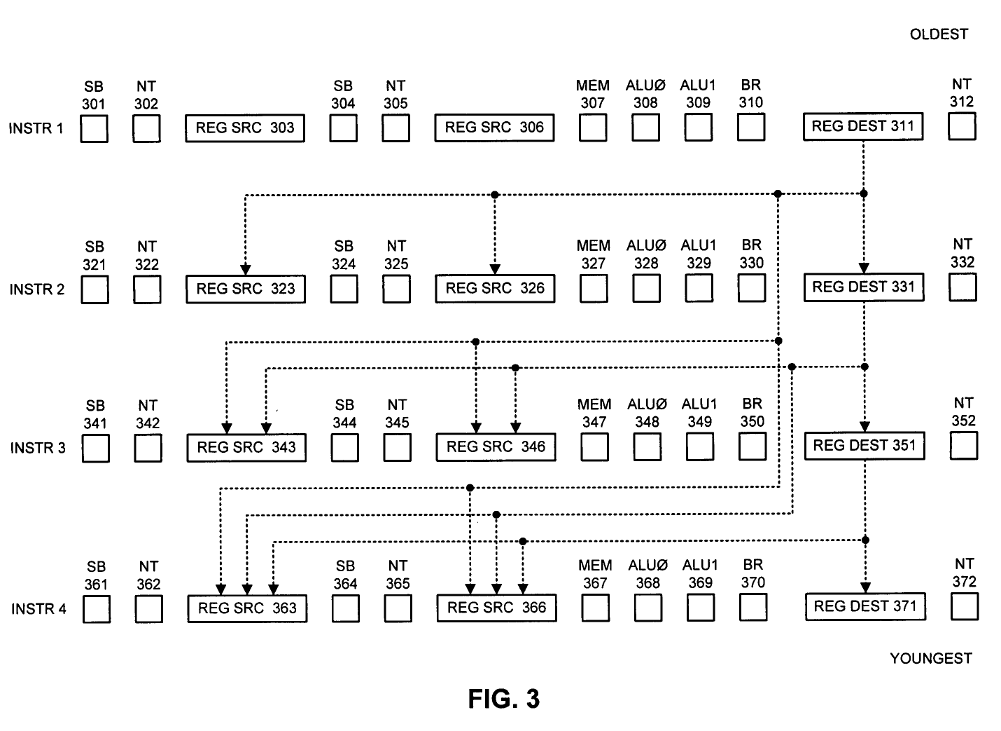

FIG. 3 illustrates dependencies and resource hazards between instructions within an “issue group” in accordance with an embodiment of the present invention. An issue group is a set of instructions that can issue at the same time by executing on parallel functional units. FIG. 3 illustrates dependencies for a four-issue machine, which can issue four instructions in parallel.

FIG. 3 illustrates dependency-related and hazard-related information for four instructions (INSTR1, INSTR2, INSTR3 and INSTR4), wherein the instructions are ordered from the oldest “INSTR1” to the youngest “INSTR4.”

Referring to FIG. 3, INSTR1 has two source registers 303 and 306. Registers 303 and 306 are associated with scoreboard bits (SBs) 301 and 304, respectively, which originate from the processor's scoreboard. When these scoreboard bits 301 and 304 are clear, source operands for INSTR1 have been computed and are available in source registers 303 and 306, which means that INSTR1 is ready to be issued.

Source registers 303 and 306 are also associated with not-there (NT) bits 302 and 305, respectively. Not-there bits 302 and 305 indicate whether or not the values in the corresponding registers 303 and 305 are subject to an unresolved data dependency that arose during speculative execution in scout mode.

INSTR1 is also associated with a destination register 311, for storing the result of INSTR1. Destination register 311 is also associated with a not-there bit 312. During execution of INSTR1, not-there bit 312 is set if either of the not-there bits 302 and 305 for the source registers 303 and 306 are set.

INSTR1 is also associated with a number of resource bits 307-310, which are used to determine if a resource hazard exists. More specifically, resource bit 307 indicates if another instruction in the issue group is using the memory pipe; resource bit 308 indicates if another instruction in the issue group is using the arithmetic logic unit 0 (ALU0); resource bit 309 indicates if another instruction in the issue group is using the arithmetic logic unit 1 (ALU1); and resource bit 310 indicates if another instruction in the issue group is using the branch pipe. Note that these resource bits are all clear for INSTR1, because it is the oldest instruction in the issue group and no preceding instructions have grabbed any of the resources. However, resource bits 307-310 will be set for following instructions.

The processor also keeps track of register dependencies between instructions within the issue group. These inter-group register dependencies are indicated by the dashed arrows in FIG. 3. For example, consider source register 363 which is associated with INSTR4. The system detects a dependency for source register 363 by determining if source register 363 matches with: destination register 311 for INSTR1; destination register 331 for INSTR2; or destination register 351 for INSTR 3. During normal non-speculative execution mode, if such a dependency exists, the dependent instruction is delayed until after the instruction upon which it depends completes.

During normal non-speculative execution mode, an instruction is allowed to issue if: the scoreboards bits are clear for all of its source registers; there are no resource hazards, and there are no register matches.

However, during scout mode, the system qualifies these conditions with the OR of the not-there bits for the source registers for each instruction. More specifically, when executing an instruction, the system first determines if either of the not-there bits for source register of the instruction are set by taking the OR of the not-there bits.

If either of the not-there bits is set, the system treats the instruction as a (no-operation) NOOP instruction. This involves disregarding the scoreboard bits, because it does not make sense for the instruction to wait for source operands when the instruction does not produce a valid result. It also involves disregarding the resource hazard bits because a NOOP will not use resources. It also involves disregarding register dependencies with instructions in the same issue group because the instruction will not produce a valid result anyway. (These conditions can be disregarded by appropriately inserting AND-gates or OR-gates into the circuitry.)

By disregarding these conditions, the instruction can execute without having to wait for: source operands to be available; resource conflicts to clear; or dependencies on instructions in the same issue group to be resolved. Moreover, the instruction does not occupy resources that other instructions in the same issue group may potentially want to use.

Note that the register dependencies illustrated in FIG. 3 are used to propagate not-there signals between instructions. More specifically, when executing an instruction as a NOOP, the not-there bit of the instruction's destination register is set if either of its source registers has its destination register set, or if the instruction depends on an older instruction in the same issue group, and the older instruction has a source register with a not-there bit that is set.

Executing Instructions in Scout Mode

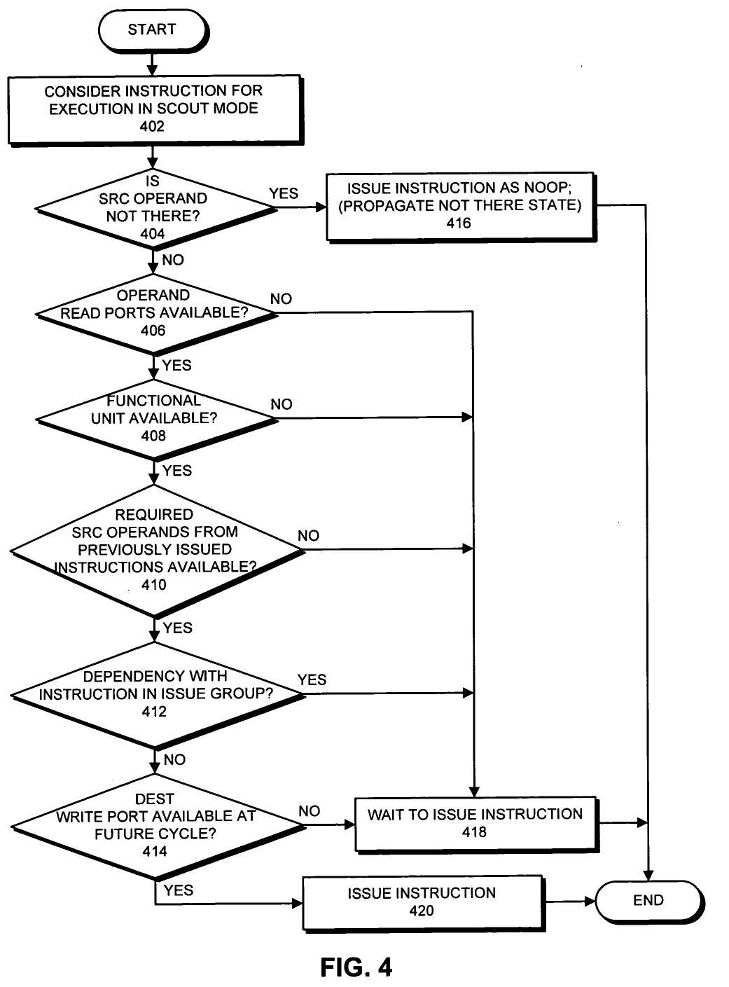

FIG. 4 presents a flow chart illustrating the process of speculatively executing an instruction in scout mode in accordance with an embodiment of the present invention. The system starts by considering an instruction for execution during scout mode (step 402). The system first determines if any source operand associated with the instruction is not-there (step 404). If so, the system issues the instruction as a NOOP, and propagates the not-there information to the destination register and to other instructions in the same issue group that depend on the instruction (step 416).

On the other hand, if there are no unresolved data dependencies, and hence no source operand is marked as not-there, the system checks a number of conditions in steps 406-414. Note that the conditions in steps 406-414 can generally be checked in parallel or in any possible order.

While checking these conditions, the system determines if: operand read ports are available from the register file (step 406); the appropriate function unit is available (step 408); the required source operands from previously issued instructions are available, which can be accomplished by checking the scoreboard bits for the source operands (step 410); that there is no dependency with an instruction in the same issue group (step 412); and that a destination write port is available for the instruction in the appropriate future cycle (step 414).

If all of these conditions are satisfied, the system issues the instruction (step 420). Otherwise, if any one of the conditions is not satisfied, the system waits to issue the instruction (step 420).

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1. A method that facilitates rapid progress while speculatively executing instructions in scout mode, comprising:
executing instructions within a processor in a normal execution mode;
upon encountering a stall condition, executing the instructions in a scout mode, wherein the instructions are speculatively executed to prefetch future loads, but wherein results are not committed to the architectural state of the processor;
wherein speculatively executing the instructions in scout mode involves maintaining dependency information for each register indicating whether or not a value in the register depends on an unresolved data-dependency; and
if an instruction to be executed in scout mode depends on an unresolved data dependency,
executing the instruction as a NOOP so that the instruction executes rapidly without tying up computational resources, and
propagating dependency information indicating an unresolved data dependency to a destination register for the instruction.

2. The method of claim 1, wherein prior to executing the instructions in scout mode, the method checkpoints the architectural state of the processor.

3. The method of claim 1, wherein when the stall condition is resolved, the method further comprises resuming non-speculative execution of the instructions in normal mode from the point of the stall condition.

4. The method of claim 1, wherein speculatively executing the instructions in scout mode involves skipping execution of floating-point and other long latency operations.

5. The method of claim 1, wherein maintaining dependency information for each register in scout mode involves:
maintaining a “not there bit” for each register, indicating whether a value in the register can be resolved;
setting the not there bit of a destination register if a load has not returned a value to the destination register; and
setting the not there bit of a destination register of an instruction if the not there bit of any source register of the instruction is set.

6. The method of claim 1, wherein executing the instruction as a NOOP involves:
not using computational resources to perform the instruction; and
not blocking other instructions from using the computational resources.

7. The method of claim 6, wherein the computational resources include:
a memory pipe;
one or more arithmetic logic units (ALUs); and
a branch pipe.

8. An apparatus that facilitates rapid progress while speculatively executing instructions in scout mode, comprising:
an execution mechanism within a processor, wherein the execution mechanism is configured to execute instructions in a normal execution mode;
wherein upon encountering a stall condition, the execution mechanism is configured to execute the instructions in a scout mode, wherein the instructions are speculatively executed to prefetch future loads, but wherein results are not committed to the architectural state of the processor;
wherein speculatively while executing the instructions in scout mode, the execution mechanism is configured to maintain dependency information for each register indicating whether or not a value in the register depends on an unresolved data-dependency; and
wherein if an instruction to be executed in scout mode depends on an unresolved data dependency, the execution mechanism is configured to,
execute the instruction as a NOOP so that the instruction executes rapidly without tying up computational resources, and to
propagate dependency information indicating an unresolved data dependency to a destination register for the instruction.

9. The apparatus of claim 8, wherein prior to executing the instructions in scout mode, the execution mechanism is configured to checkpoint the architectural state of the processor.

10. The apparatus of claim 8, wherein when the stall condition is resolved, the execution mechanism is configured to resume non-speculative execution of the instructions in normal mode from the point of the stall condition.

11. The apparatus of claim 8, wherein while speculatively executing the instructions in scout mode, the execution mechanism is configured to skip execution of floating-point and other long latency operations.

12. The apparatus of claim 8, wherein while maintaining dependency information for each register in scout mode, the execution mechanism is configured to:
maintain a “not there bit” for each register, indicating whether a value in the register can be resolved;
set the not there bit of a destination register if a load has not returned a value to the destination register; and to
set the not there bit of a destination register of an instruction if the not there bit of any source register of the instruction is set.

13. The apparatus of claim 8, wherein while executing the instruction as a NOOP involves, the execution mechanism is configured to:
not use computational resources to perform the instruction; and to
not block other instructions from using the computational resources.

14. The apparatus of claim 8, wherein the computational resources include:
a memory pipe;
one or more arithmetic logic units (ALUs); and
a branch pipe.

15. The apparatus of claim 8, wherein while executing the instruction as a NOOP, the execution mechanism is configured to allow the instruction to issue even if the processor's scoreboard indicates that a source operand for the instruction is not available.

16. The apparatus of claim 13,
wherein the execution mechanism is configured to issue multiple instructions that belong to the same issue group simultaneously; and
wherein while executing the instruction as a NOOP, the execution mechanism is configured to allow other instructions in the same issue group to issue despite a data dependency on the instruction.

17. The apparatus of claim 16, wherein while determining if an instruction to be executed in scout mode depends on an unresolved data dependency, the execution mechanism is configured to consider both intra-group dependencies on source registers for other instructions in the same issue group, and direct dependencies on source registers for the instruction.

18. The apparatus of claim 8, wherein an unresolved data dependency can include:
a use of an operand that has not returned from a preceding load miss;
a use of an operand that has not returned from a preceding translation lookaside buffer (TLB) miss;
a use of an operand that has not returned from a preceding full or partial read-after-write (RAW) from store buffer operation; and
a use of an operand that depends on another operand that is subject to an unresolved data dependency.

19. The apparatus of claim 8, wherein the stall condition can include:
a memory barrier operation;
a load buffer full condition; and
a store buffer full condition.

20. A computer system that facilitates rapid progress while speculatively executing instructions in scout mode, comprising:
a processor;
a memory;
an execution mechanism within the processor, wherein the execution mechanism is configured to execute instructions in a normal execution mode;
wherein upon encountering a stall condition, the execution mechanism is configured to execute the instructions in a scout mode, wherein the instructions are speculatively executed to prefetch future loads, but wherein results are not committed to the architectural state of the processor;
wherein speculatively while executing the instructions in scout mode, the execution mechanism is configured to maintain dependency information for each register indicating whether or not a value in the register depends on an unresolved data-dependency; and
wherein if an instruction to be executed in scout mode depends on an unresolved data dependency, the execution mechanism is configured to,
execute the instruction as a NOOP so that the instruction executes rapidly without tying up computational resources, and to
propagate dependency information indicating an unresolved data dependency to a destination register for the instruction.
